(19) United States
(12) Patent Application Publication
(10) Pub. No.: US 2007/0208432 A1
(43) Pub. Date: Sep. 6, 2007

(54) HYDROCARBON FLUID PROCESSING PLANT DESIGN

(76) Inventor: Daniel J. Hawrysz, HOUSTON, TX (US)

Correspondence Address: ExxonMobil Upstream Research Company, P.O.Box 2189, CORP-URC-SW348, Houston, TX, 77252-2189, US

(21) Appl. No.: 11/579,193

(22) PCT Filed: May 31, 2005
(86) PCT No.: PCT/US05/18979

§ 371 Date: Oct. 31, 2006

Related U.S. Application Data
(60) Provisional application No. 60/580,775, filed on Jun. 18, 2004.

(51) Int. Cl. G05B 15/00; F25J 1/00

(52) U.S. Cl. 700/1; 62/611

(57) ABSTRACT

The current invention is related to methods of designing hydrocarbon fluid processing plants and methods of producing hydrocarbon fluids using hydrocarbon fluid processing plants. More particularly, some embodiments of the invention are related to methods of designing natural gas liquefaction plants and methods of producing LNG using natural gas liquefaction plants. One embodiment of the invention includes a method of designing a hydrocarbon fluid processing plant, including: A) providing a process unit configuration for one or more processing units included in a hydrocarbon fluid processing plant; B) determining a cost to capacity relationship for a plurality of equipment types included in the one or more processing units; C) running a process simulation model to obtain a process simulation for the process unit configuration, the process simulation including the estimated capacity of the plurality of equipment types; D) determining a cost measure for the process simulation, the cost measure including an equipment cost measure determined using said estimated capacity of the plurality of equipment types and the cost to capacity relationships; E) altering a process variable in the process simulation model; and F) repeating steps C through E a plurality of times.

### CROSS REFERENCE TO RELATED APPLICATIONS

This application claims the benefit of U.S. Provisional Application 60/580,775, filed Jun. 18, 2004.

### FIELD OF THE INVENTION

The current invention is related to methods of designing hydrocarbon fluid processing plants, and methods of producing hydrocarbon fluids using hydrocarbon fluid processing plants. More particularly, some embodiments of the invention are related to methods of designing natural gas liquefaction plants and methods of producing LNG using natural gas liquefaction plants.

### BACKGROUND

Large volumes of natural gas (i.e. primarily methane) are located in remote areas of the world. This gas has significant value if it can be economically transported to market. Where the gas reserves are located in reasonable proximity to a market and the terrain between the two locations permits, the gas is typically produced and then transported to market through submerged and/or land-based pipelines. However, when gas is produced in locations where laying a pipeline is infeasible or economically prohibitive, other techniques must be used for getting this gas to market.

A commonly used technique for non-pipeline transport of gas involves liquefying the gas at or near the production site and then transporting the liquefied natural gas to market in specially-designed storage tanks aboard transport vessels. The natural gas is cooled and condensed to a liquid state to produce liquefied natural gas (“LNG”). LNG is typically, but not always, transported at substantially atmospheric pressure and at temperatures of about −162° C. (−260° F.), thereby significantly increasing the amount of gas which can be stored in a particular storage tank on a transport vessel. Once an LNG transport vessel reaches its destination, the LNG is typically off-loaded into other storage tanks from which the LNG can then be revaporized as needed and transported as a gas to end users through pipelines or the like. LNG has been an increasingly popular transportation method to supply major energy-consuming nations with natural gas.

Processing plants used to liquefy natural gas are typically built in stages as the supply of feed gas, i.e. natural gas, and the quantity of gas contracted for sale, increase. One traditional method of building an LNG processing plant is to build up a plant site in several sequential increments, or parallel trains. Each stage of construction may consist of a separate, stand-alone train, which, in turn, is comprised of all the individual processing units or steps necessary to liquefy a stream of feed gas into LNG and send it on to storage. Each train may function as an independent production facility. Train size can depend heavily upon the extent of the resource, technology and equipment used within the train, the available funds for investment in the project development, and market conditions.

A hydrocarbon fluid processing plant may be designed in various ways known in the art. Typically, a hydrocarbon fluid processing plant is designed using a process simulation model where the design engineer picks what he believes to be the highest cost equipment type and he attempts to minimize the capacity of the selected highest cost equipment type. For example, in an LNG plant, the design engineer might select refrigerant compressor horsepower as the process variable to minimize in the process simulation modeling process in order to minimize the size and cost of the refrigerant compressors. However, this methodology does not incorporate the cost of the refrigerant compressors or the cost of any other equipment types into the process simulation modeling process.

Due to the increase in LNG demand seen in recent years, increased emphasis has been placed on cost, design and schedule efficiency of new gas liquefaction projects in order to reduce the cost of the delivered gas. Improvements in cost, design, and schedule efficiency can help mitigate the substantial commercial risk associated with large LNG development projects.

### SUMMARY

One embodiment of the invention includes a method of designing a hydrocarbon fluid processing plant, including: A) providing a process unit configuration for one or more processing units included in a hydrocarbon fluid processing plant; B) determining a cost to capacity relationship for a plurality of equipment types included in the one or more processing units; C) running a process simulation model to obtain a process simulation for the process unit configuration, the process simulation including the estimated capacity of the plurality of equipment types; D) determining a cost measure for the process simulation, the cost measure including an equipment cost measure determined using said estimated capacity of the plurality of equipment types and the cost to capacity relationships; E) altering a process variable in the process simulation model; and F) repeating steps C through E a plurality of times.

An alternate embodiment of the invention includes a method of producing a hydrocarbon fluid product, the hydrocarbon fluid product produced from a hydrocarbon fluid processing plant, the hydrocarbon fluid processing plant designed at least partially using the following steps: a) providing a process unit configuration for one or more processing units included in the hydrocarbon fluid processing plant; b) determining a cost to capacity relationship for a plurality of equipment types included in the one or more processing units; c) running a process simulation model to obtain a process simulation for the process unit configuration, the process simulation including the estimated capacity of the plurality of equipment types; d) determining a cost measure for the process simulation, the cost measure including an equipment cost measure determined using said estimated capacity of the plurality of equipment types and the cost to capacity relationships; e) altering a process variable in the process simulation model; and f) repeating steps c through e a plurality of times, the method comprising producing the hydrocarbon fluid product from the hydrocarbon fluid processing plant.

An alternate embodiment of the invention includes a tangible media including a set of instructions readable by a computer, the set of instructions including: A) a process configuration module suitable for inputting a process unit configuration for one or more processing units included in a hydrocarbon fluid processing plant; B) a register module suitable for storing cost to capacity relationships for a plurality of equipment types included in the one or more processing units; C) a process simulation model suitable for obtaining a process simulation for a process unit configuration, the process simulation suitable for estimating the capacity of said plurality of equipment types; D) a cost calculation module suitable for determining a cost measure for the process simulation, the cost measure including an equipment cost measure determined using the estimated capacity of the plurality of equipment types and the cost to capacity relationships; E) a process variable interfacing module suitable for allowing alteration of a process variable of the process simulation model; F) a repetition module suitable for repeating modules C through E a plurality of times; and G) an output module suitable for producing a data display.

### BRIEF DESCRIPTION OF THE DRAWINGS

FIG. 1 is a block flow diagram of one exemplary configuration of an LNG liquefaction plant.

FIG. 2 is a logical block flow diagram of one embodiment of the method of the current invention.

FIG. 3 is a logical block flow diagram of another embodiment of the method of the current invention.

FIG. 4 is one graphical depiction of one embodiment of process unit configuration for an acid gas removal contactor unit.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology. Various terms as used herein are defined below. To the extent a term used in a claim is not defined below, it should be given the broadest definition persons in the pertinent art have given that term as reflected in printed publications and issued patents.

As used herein and in the claims the phrase “hydrocarbon fluid processing plant” means any processing plant that processes a hydrocarbon fluid feed into a product that is changed in some way from the feed. For example, the feed may be changed in composition, physical state and/or combinations of physical state and composition. One example of a hydrocarbon fluid processing plant is a LNG liquefaction plant.

As used herein and in the claims the phrase “process unit configuration” means a process flow scheme for a process unit or hydrocarbon fluid processing plant that includes at least the arrangement of equipment types and the arrangement of flow paths for transporting the process fluids among the equipment types. A process unit configuration may also optionally include operating conditions and constraints for the equipment types.

As used herein and in the claims the phrase “process unit” and “processing unit” mean any set of operations that completes a processing step in a hydrocarbon fluid processing plant or supports a process unit that completes a processing step in a hydrocarbon fluid processing plant. For example, processing steps include steps which change the temperature, pressure, composition, physical state and/or combinations of temperature, pressure, physical state and composition of a material. Additionally, process units which support a process unit that completes a processing step include, for example, process units that provide electricity, steam, and/or cooling water to process units which complete a processing step. Non-limiting examples of process units include utility units, gas preheat units, slug catcher units, offgas compressor units, condensate stabilizer units, acid gas removal contactor units, acid gas removal regenerator units, sulfur recovery units, dehydration units, deethanizer units, fractionation units, cryogenic heat exchanger units, refrigerant compressor units, nitrogen rejection units, cogeneration units, liquefaction units, helium recovery units, compression units, and combinations thereof.

As used herein and in the claims the phrase “cost to capacity relationship” means any relationship of the cost of a piece or pieces of equipment of an equipment type related to the capacity of such equipment of an equipment type. Generally, for a given type of processing equipment the cost of the piece of processing equipment increases as the size (capacity) of the piece of processing equipment increases. An example of a cost to capacity relationship is an equation relating equipment type cost to equipment type capacity. For example, cost to capacity relationship includes linear, non-linear, continuous and discrete functions that relate the size or throughput capacity to the cost of the equipment type.

As used herein and in the claims the phrase “equipment types” means any type of processing equipment used in any type of processing units. Non-limiting examples of equipment types include compressors, heat exchangers, distillation columns, flash drums, reactors, pumps, expanders, gas turbines, motors, fired heaters, liquid/gas contactors, liquid/gas separation drums and other processing equipment used in hydrocarbon fluid processing plants.

As used herein and in the claims the phrase “process simulation model” means any mathematical modeling program used for simulating the processing of hydrocarbon fluids in a hydrocarbon fluid processing plant or processing unit. Examples of process simulation models include, for example, commercially available models such as Hysim™, Pro II™, Hysys™, Aspen™, and ChemCAD™.

As used herein and in the claims the phrase “process simulation” means the simulated case developed by the process simulation model. A process simulation may include one or more of the following information: required capacity for an equipment type; flow rate of feed, intermediate and product hydrocarbon fluid streams; steam usage; electrical requirements; process feed water requirements; temperature and pressure of feed, intermediate and product hydrocarbon fluid streams; composition of feed, intermediate and product hydrocarbon fluid streams; and the identity of equipment types.

As used herein and in the claims the phrase “estimated capacity” means an estimate of the capacity required for an equipment type as calculated by a process simulation model. Estimated capacity may be estimated in any units that are representative of a capacity measure. Estimated capacity may be in the form of, for example, a fluid mass flow rate, a fluid volumetric flow rate, a fluid molar flow rate, a heat exchanger area, a heat exchanger duty, a compressor horsepower, a compressor flow rate, a compressor head, the number of theoretical or actual separation stages in a distillation column, a pump horsepower, a pump flowrate, a pump head, the size of a process vessel or other manner of representing the capacity of an equipment type.

As used herein and in the claims the phrase “cost measure” means any manner of representing a cost that would be incurred if a process unit, hydrocarbon fluid processing plant, or portions thereof, represented by the process simulation, were actually constructed and/or operated. Cost measure may include one or more measures of representing a cost that would be incurred if a process unit, hydrocarbon fluid processing plant, or portions thereof, represented by the process simulation, were actually constructed and/or operated. A cost measure may be a debit or a credit. Non-limiting examples of cost measures may include one or more of the following: equipment cost measure, utility cost measure and/or product value cost measure.

As used herein and in the claims the phrase “equipment cost measure” means any one or more of a measure representing the cost of designing, procuring, delivering, constructing, installing, and/or operating one or more equipment types. For example, one representation of equipment cost measure is the equipment capacity, as determined by a process simulation model and the cost to capacity relationship for a particular or group of equipment types.

As used herein and in the claims the phrase “utilities cost measure” means any measure which is representative of the utility cost of operating an equipment type, process unit and/or hydrocarbon fluid processing plant. For example, utility cost measure may include any one or more of the cost of steam production, water requirements, and/or electricity usage. For example, one representation of utility cost measure is the electricity consumption, as determined by a process simulation model, multiplied by the cost per unit for electricity.

As used herein and in the claims the phrase “product value cost measure” means any measure representative of the value of the salable products produced in a process unit or hydrocarbon fluid processing plant. For example, product value cost measure may include any one or more of the value of hydrocarbon fluid product streams (e.g. LNG, propane, natural gas liquids), non-hydrocarbon product streams (e.g. sulfur, helium) or other salable entities produced by a processing unit and/or hydrocarbon fluid processing plant. For example, product value cost measure may be calculated using the market price for a commodity or the price negotiated under an existing contract with a buyer of a commodity. For example, one representation of product value cost measure is the LNG production rate, as determined by a process simulation model, multiplied by the market value per unit for LNG.

As used herein and in the claims the phrase “process variable” means any process variable that can be altered in any process simulation model. Non-limiting examples of process variables include: a fluid mass flow rate; a fluid volumetric flow rate; a fluid molar flow rate; a heat exchanger area; a heat exchanger duty; a compressor horsepower; the number of theoretical or actual separation stages in a distillation column; the size of a process vessel; the flow rate of feed, intermediate and product hydrocarbon fluid streams; steam usage; electrical usage; process feed water flow rate; the temperature and pressure of feed, intermediate and product hydrocarbon fluid streams; the composition of feed, intermediate and product hydrocarbon fluid streams; and identity of equipment types.

As used herein and in the claims the phrase “LNG liquefaction plant” means a hydrocarbon fluid processing plant that includes processing a feed stream which comprises gaseous methane into a product stream that includes liquid methane. For example an LNG liquefaction plant may include a cryogenic heat exchanger, refrigerant compressors and/or an expansion step. An LNG liquefaction plant may optionally include other fluid processing steps. Non-limiting examples of optional fluid processing steps include feed purification processing steps (liquids removal, hydrogen sulfide removal, carbon dioxide removal, dehydration), product purification steps (helium removal, nitrogen removal), and non-methane product production steps (deethanizing, depropanizing, sulfur recovery). One example of an LNG liquefaction plant includes, for example, a plant that converts a gaseous feed stream containing methane, ethane, carbon dioxide, hydrogen sulfide and other species to liquefied natural gas which contains methane and reduced amounts of other non-methane species as compared to the feed stream.

As used herein and in the claims the phrase “higher cost equipment types” means an equipment type that represents more than 10 percent of the cost of designing, procuring, delivering, constructing, installing, and/or operating a process unit.

As used herein and in the claims the phrase “capital cost basis” means any cost basis that represents capital or non-capital costs on a capital cost basis. Capital costs typically represent costs to design, procure, construct, and install equipment, as well as any other costs incurred by a project prior to the initial startup of the plant or plant modification. Non-capital costs, such as continuous operating costs, can be equivalently compared to capital costs by determining the “Present Value” of such continuous costs, which is a technique commonly employed by those skilled in the art.

As used herein and in the claims the phrase “transportation vessel” means any vessel which is capable of transporting a hydrocarbon fluid product over land or water. Transportation vessels may include one or more of rail cars, tanker trucks, barges, ships or other means of traveling over land or water.

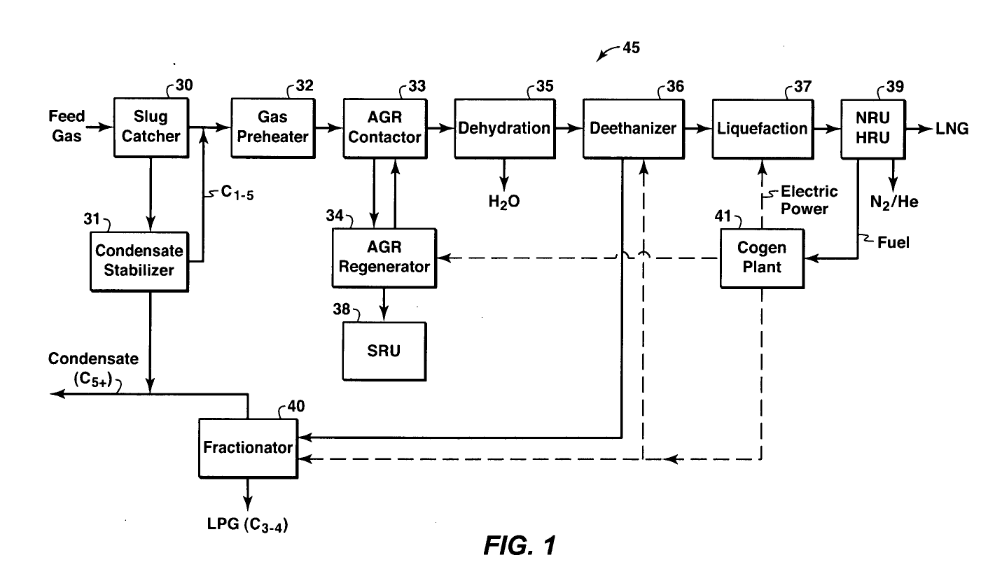

The methodologies described herein may be used to design, construct and operate any type of hydrocarbon fluid processing plant. For exemplary purposes one general arrangement of one type of hydrocarbon fluid processing plant will be briefly described with reference to FIG. 1 depicting an exemplary LNG liquefaction plant.

An LNG liquefaction plant 45 may consists of several discrete processing sections. Exemplary processing sections include the inlet facilities, gas treating, dehydration, gas liquefaction, refrigerant compression, and refrigerant preparation, each of which may be carried out in one or more process unit module types. The concept is most easily described through using an example of a LNG liquefaction plant contained in FIG. 1.

Feed gas is received into the inlet facilities, which separate the gas from liquid water and any hydrocarbon liquids (condensate) that may be present. The inlet facilities may also stabilize the condensate into a salable product. The inlet facilities may consist of a slug catcher unit 30, various separation vessels (not shown), a condensate stabilizer unit 31, an off gas compressor unit (not shown) to return the condensate stabilizer offgas to the main gas stream, and a feed gas preheat unit 32. The feed stream is initially passed through a slug catcher and separation equipment (not shown) to remove the bulk of the components that tend to cause freezing and plugging problems in a cryogenic process. Condensed liquids (gas condensate) separated from the gas stream are generally at high pressure, such as 500-1000 psig or higher and contain significant amounts of dissolved methane and ethane. For transportation and subsequent use, the condensate is typically stabilized in the condensate stabilizer unit 31; that is, the vapor pressure is reduced, typically below atmospheric pressure. Removing the light hydrocarbons to lower the vapor pressure not only increases the heating value of the condensate product, but it also reduces potential problems caused by later off-gassing of the light components, as the pressure and temperature of the condensate change during transport and storage.

The major process functional areas in the gas treating and dehydration section are the acid gas removal (AGR) system, including the AGR contactor unit 33 and AGR regenerator unit 34, mercury adsorbent (not shown), and dehydration unit 35. A variety of processes have been used to treat the gas to remove acid gases (H₂S and CO₂). One process for treating a sour gas stream involves contacting the gas stream in a contactor vessel with a solvent (e.g., organic amines, such as methyldiethanolamine, and other additives) which absorbs the acid gases and carries them out of the gas stream.

In order for processes of this type to be economical, the “rich” solvent must be regenerated in the AGR regenerator unit 34 so that it can be reused in the treatment process. That is, the acid gases (both CO₂ and H₂S) and the hydrocarbons are removed or substantially reduced in the rich solvent before it can be reused in the process. The rich solvent may be regenerated by passing it into a regenerator vessel where substantially all of the acid gases are removed, after which the regenerated solvent is returned for use in the treatment process. A sulfur product may then be recovered from the H₂S by processing the recovered acid gas stream through a Sulfur Recovery Unit (SRU) 38.

A dehydration unit 35, using molecular sieves and/or glycol processes for example, removes H₂O to a dew point level compatible with the LNG product temperature of −260° F. The dehydration adsorbent vessels may generally be comprised of parallel vessels which cycle from dehydrating the feed gas to regenerating mode.

The gas liquefaction section 37 generally contains one or more cryogenic heat exchanger units and optionally one or more pre-cooling heat exchanger units for cooling the natural gas stream by heat exchange with one or more refrigerants. The cryogenic heat exchangers used in the cryogenic heat exchanger unit may be, for example, spiral wound heat exchanges, sometimes referred to as spool wound heat exchangers, or brazed aluminum, plate-fin heat exchangers.

The refrigerant compression units (not shown) take the evaporated refrigerant exiting the cryogenic heat exchangers and/or pre-cooling heat exchangers and compresses it to a pressure sufficient for its condensation and re-use. LNG liquefaction plants may have one or more refrigerant compression circuits that may use single component refrigerants (e.g. propane) or mixed refrigerants (e.g. methane, ethane and propane). Where two or more refrigerant circuits are employed the respective circuits may cool the natural gas stream in series, in parallel or in a cascade arrangement where one refrigerant circuit is used to cool a second refrigerant, which in turn cools the natural gas stream.

Although many refrigeration cycles may be used to liquefy natural gas, the following three types are further illustrated: (1) “cascade cycle” which uses multiple single component refrigerants in heat exchangers arranged progressively to reduce the temperature of the gas to a liquefaction temperature, (2) “expander cycle” which expands gas from a high pressure to a low pressure with a corresponding reduction in temperature, and (3) “mixed refrigeration cycle” which uses a multi-component refrigerant in specially designed heat exchangers. Most natural gas liquefaction cycles use variations or combinations of these three basic types.

A mixed refrigerant gas liquefaction system involves the circulation of a multi-component refrigeration stream, usually after precooling with propane or another mixed refrigerant. An exemplary multi-component system may comprise methane, ethane, propane, and optionally other light components. Without precooling, heavier components such as butanes and pentanes may be included in the multi-component refrigerant. Mixed refrigerants exhibit the desirable property of condensing and evaporating over a range of temperatures, which allows the design of heat exchange systems that can be thermodynamically more efficient than pure component refrigerant systems.

The refrigerant preparation unit (not shown) contains one or more distillation columns that can produce from the feed gas ethane, propane, etc., products that can be used to compose some or all of the refrigerants used within the liquefaction unit 37.

Another optional component of the gas liquefaction section 37 or a separate stand alone unit, is a distillation tower, such as a scrub tower (not shown), demethanizer unit (not shown), or deethanizer unit 36, that has as least the function of removing pentane and heavier components from the feed gas to prevent freezing in the cryogenic heat exchangers. Some plants may use a demethanizer unit or deethanizer unit 36 instead in order to produce some natural gas liquids as separate products. Natural gas leaving the dehydration unit 35 may be fractionated. In this schematic, part of the C₃₊ hydrocarbons containing at least three carbon atoms are separated from the natural gas by means of a deethanizer distillation column. The light fraction collected at the top of the deethanizer column is passed to the liquefaction unit 37. The liquid fraction collected at the bottom of the deethanizer column is sent to a fractionation unit 40 for recovery of C₃₋₄ liquid petroleum gas (LPG) and C₅₊ liquid (condensate). This arrangement is preferred if the LPG product is intended to be sold separately. In locations where the feed gas has a low LPG content or the LPG has low value, the deethanizer column may be replaced by a scrub tower which removes pentane and heavier hydrocarbons to a specified level.

An LNG plant may also include a sulfur recovery unit (SRU) 38 and nitrogen rejection unit (NRU) 39, a perhaps a helium recovery unit (HRU) 39. Several processes have been developed for direct conversion of H₂S to elemental sulfur. Most conversion processes are based on oxidation-reduction reactions where H₂S is converted directly to sulfur. In large liquefaction trains, the Claus process converts H₂S to sulfur by “burning” a portion of the acid gas stream with air in a reaction furnace. This provides SO₂ for reaction with unburned H₂S to form elemental sulfur by the Claus reaction: 2H₂S+SO₂→3/2S₂+2H₂O.

At the end of the liquefaction process 37, the LNG may be treated to remove nitrogen (NRU) and perhaps to recover helium (HRU) 39, if any is present. Processes to accomplish this purification can be provided by licensors. A large portion of the nitrogen that may be present in natural gas is typically removed after liquefaction since nitrogen will not remain in the liquid phase during transport of conventional LNG and having nitrogen in LNG at the point of delivery is undesirable due to sales specifications. For storage and/or shipping the pressure of the liquefied natural gas is usually decreased to near atmospheric pressure. Such pressure reduction is often called an “end flash” reduction, resulting in end flash gas and LNG. An advantage of such an end flash reduction is that low boiling components, such as nitrogen and helium, are at least partially removed from the LNG along with some methane. The end flash gas may be used as fuel gas in a cogeneration plant 41 or for gas turbine drivers, steam boilers, fired heaters, or other areas as required. The helium recovery is optional depending on the amount of helium in the natural gas feed stream and the market value of helium.

Cogeneration units 41 may be used to reduce costs associated with energy usage in commercial and industrial operations. In an exemplary cogeneration unit 41, an electrical power generator, such as a gas-fired turbine driving a generator, is used to generate electricity for supplying the electrical needs of the plant. Any excess electrical power generated can be sold to a power company or used in the LNG plant, and electrical power is purchased from the power company only to the extent necessary to supplement the amount of electrical power produced by the cogeneration unit 41. Wastes such as heat loss are reduced by utilizing heat generated as a result of production of electrical power for supplying or at least contributing to the heat and/or cooling demands for the plant. Heat produced as a result of operation of the gas-fired turbine may be extracted from the exhaust gases by way of a heat exchanger and used in supplying heating demands for the plant, such as steam. Alternatively, the steam generated from this process is used to generate more electricity in a steam-driven turbine-generator.

A hydrocarbon fluid processing plant may be designed in various ways known in the art. Typically, a hydrocarbon fluid processing plant is designed using a process simulation model where the design engineer picks what he believes to be the highest cost equipment type and he attempts to minimize the capacity of the selected highest cost equipment type. For example, in an LNG liquefaction plant, the design engineer might select refrigerant compressor horsepower as the process variable to minimize in the process simulation modeling process in order to minimize the size and cost of the refrigerant compressors. However, this methodology does not incorporate the cost of the refrigerant compressors or the cost of any other equipment types into the process simulation modeling process.

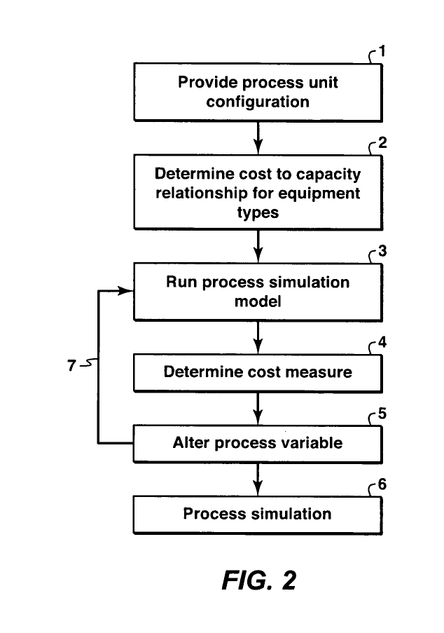

One embodiment of the current invention includes a method of designing a hydrocarbon fluid processing plant where the costs of a plurality of the equipment types included in the hydrocarbon fluid processing plant under design are evaluated in the design methodology. FIG. 2 presents a block flow diagram of the steps included in one embodiment of the invention and will be referred to herein throughout the detailed description. In one embodiment the method may include one or more of the following aspects. In designing a hydrocarbon fluid processing plant or one or more processing units within a hydrocarbon fluid processing plant the designer may provide a process unit configuration 1 for the one or more processing units of the plant. The process unit configuration may include the process flow scheme of each process unit. The process flow scheme may include the arrangement of the process equipment types with respect to the flow streams in the process unit. This may include the order and identity of which feed, intermediate and/or product streams flow into and out of the respective equipment types or processing steps included in a process unit included in the design.

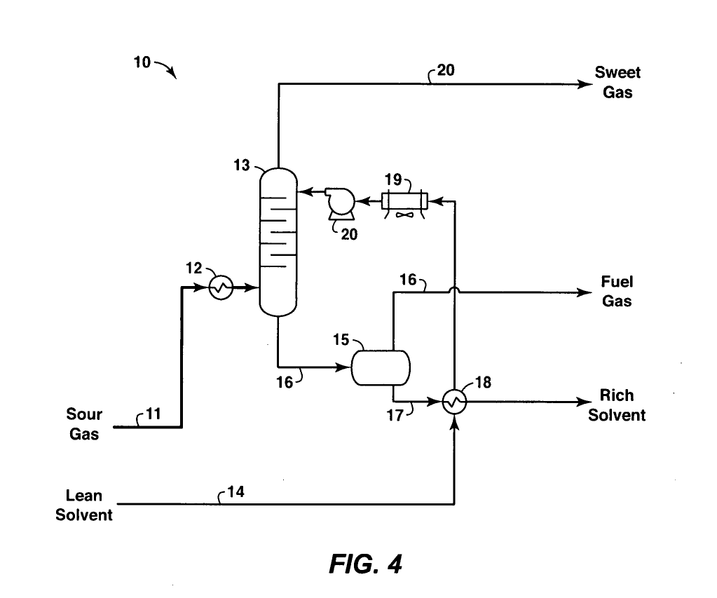

FIG. 4 provides a graphical representation of an exemplary process unit configuration for one acid gas removal unit that could be a part of an LNG liquefaction plant. FIG. 4 depicts a feed stream 11 containing sour natural gas (i.e. containing hydrogen sulfide) entering the acid gas removal unit 10. The feed stream flows to first heat exchanger 12 for heating before it enters solvent contactor 13. In solvent contactor 13, the gaseous feed stream 11 is placed into contact with a lean solvent 14. The solvent 14 may be, for example, an amine solvent. In the solvent contactor 13, the hydrogen sulfide gas, other sulfur containing components, and/or carbon dioxide contained in the feed stream 11 is dissolved into the liquid solvent 14. The remaining gaseous hydrocarbon portion of the feed stream exits the top of the solvent contactor as a sweet natural gas stream 20. The rough cut rich solvent 16 (i.e. containing hydrogen sulfide, some methane and solvent) exits the bottom of the solvent contactor 13 and enters a flash drum 15. In the flash drum 15, the pressure of the rough cut rich solvent 16 is reduced, thereby producing a flash gas 16 containing methane which can be used as fuel gas 17 for a plant. The liquid stream 17 leaving the flash drum 15 is comprised of rich solvent (i.e. contains hydrogen sulfide and solvent) and flows to a second heat exchanger 18 where the liquid stream 17 is heated before leaving the acid gas removal unit 10 for regeneration in an acid gas regeneration unit (not shown). Following regeneration, the hot lean solvent 14 passes through second heat exchanger 18 where the lean solvent 14 is cooled by heat exchange with the liquid stream 17 exiting the flash drum 15. The lean solvent 14 is further cooled by a fin fan heat exchanger 19 before being pumped by pump 20 into the solvent contactor 13. Additionally, a process unit configuration may optionally include further specification of the various feed, product and intermediate streams, including, for example, the temperature, pressure, flow rate and/or composition of one or more of such streams.

The method may also include determining a cost to capacity relationship for one or more of the equipment types 2 included in the process unit configuration 1. A cost to capacity relationship can be any relationship that relates cost to capacity for a respective or group of equipment types. In one embodiment the cost to capacity relationship is determined by regressing cost data for different size (capacity) pieces of equipment for an equipment type over a selected capacity range to obtain a linear or non-linear equation. The cost data may, for example, be data provided by one or more vendors of a particular equipment type (e.g. compressors) or actual cost data collected from construction of prior plants using the same or similar equipment. The cost data may be related to any type of capacity measure for the equipment type. For example, in the case of a compressor, horsepower may be used. In the case of a heat exchanger, heat exchange area or duty may be used.

One exemplary method of determining a cost to capacity relationship is presented below. Several data points relating cost to capacity may be compiled from vendor sources or data from past purchases. Table 1 lists representative capacities and costs for a certain type of shell and tube heat exchanger. For the case of this example, the capacity measure listed in Table 1 is the heat exchanger area. A model may be selected to relate the capacity to the cost. One exemplary model is C=C_{b}*(X/X_{b})^{Y}, although other statistical methods can be used to select an alternative model. Here, C is the predicted equipment cost, C_{b} is a preselected cost basis, X is the equipment capacity, X_{b} is a preselected capacity basis, and Y is a scaling exponent. In this model, C_{b} and X_{b} are selected from the data set, X is predicted by the process model, and Y is regressed from the data set. For this example, the capacity basis is selected to be the median of the data set, 22,004 ft², with a corresponding cost of $199,818. A value for Y may be assumed and the column of Predicted Cost may be populated. The predicted cost at each capacity measure is compared with the actual cost to compute the sum of squared errors (SSE), a standard measure of model fitting. The value of Y is then varied in order to minimize the SSE, thereby improving the fit of the model to the data. Many methods of selecting the optimum value of Y are available to those skilled in the art.

TABLE 1
Example of regression of cost to capacity relationship
for a certain type of shell and tube heat exchanger

| Area (ft\hat{ }2) | Actual Cost | Predicted Cost | Difference | Square Error |
|---|---|---|---|---|
| 20,028 | $190,322 | $190,435 | −113 | 1.29E+04 |
| 20,958 | $196,028 | $194,906 | 1122 | 1.26E+06 |
| 22,004 | $199,818 | $199,818 | 0 | 0.00E+00 |
| 22,959 | $204,601 | $204,206 | 395 | 1.56E+05 |
| 24,081 | $208,707 | $209,246 | −538 | 2.90E+05 |
| | | | SSE: | 1.72E+06 |

| | |
|---|---|
| Cost Base C_{b}: | $199,818 |
| Capacity Base X_{b}: | 22,004 |
| Exponent Y: | 0.51 |

The method may also include running a process simulation model 3 using the process unit configuration as input to the process simulation model. Various commercially available process simulation models exist. These models generally take a set of inputs, including for example a process unit configuration, and determine the character and conditions of process streams that run through processing steps in a process unit by using a set of thermodynamic models and physical property correlations. Process simulation models may also be used to determine the required capacity of equipment types performing processing steps in the model. For example, a process simulation model can be used to determine the required duty and/or heat exchanger area required to heat or cool a process stream of a certain composition and pressure from a first temperature to a second temperature. A process simulation model may also be used to determine the required horsepower of a compressor used to compress a gaseous stream of a certain composition and temperature from a feed inlet pressure to a desired outlet pressure. The previous examples are provided for illustrative purposes and are not intended to limit the many other capacity determinations which may be determined using a process simulation model. In embodiments of the method the process simulation model may be used to determine a process simulation that includes capacity requirements for one or more equipment types included in a process unit.

Embodiments of the method may include determining a cost measure 4 for the process simulation obtained from the process simulation model. The cost measure may be representative of the cost that would be incurred if the process unit and/or fluid processing plant were actually constructed and/or operated. The cost measure may be made up of different components which can be summed to obtain a cost measure. Exemplary alternative components that can be used to determine a cost measure include an equipment cost measure, a utility cost measure and/or a product value cost measure.

The equipment cost measure is meant to be representative of the cost of designing, procuring, delivering, constructing, installing and/or operating equipment of an equipment type meeting the required capacity determined by the process simulation model for a process unit. Thus the equipment cost measure may be obtained from the cost to capacity relationship for an equipment type and the capacity for such equipment type as determined by the process simulation model.

A utility cost measure is meant to be representative of the utility cost of operating an equipment type, process unit and/or hydrocarbon fluid processing plant of a capacity as determined by the process simulation model. Non-limiting examples of utility costs include the cost of steam production, electricity consumption, and/or cooling water requirements for an equipment type, process unit and/or a hydrocarbon fluid processing plant.

A product value cost measure is meant to be representative of the value of the salable products produced in a process unit or hydrocarbon fluid processing plant. The products may be hydrocarbon fluid products, non-hydrocarbon fluid products or other salable entities.

In one embodiment the cost measure may be determined on a capital cost basis. A capital cost basis is any basis that represents capital or non-capital costs on a capital cost basis. For example, the utility cost measure may be totaled over a length of time and then adjusted to represent the utility cost on a capital cost basis so that it can be compared to the equipment cost measure on a capital cost basis. Similarly, the product value cost measure can be adjusted to represent the product value cost on a capital cost basis so that it can be compared to the equipment cost measure on a capital cost basis. Any cost or revenue that is paid or received over time can be converted to a capital cost basis by computing its present value. The present value of any amount of money paid or received in the future can be calculated, for example, by P=F*(1+i)ⁿ, where F is a payment or revenue amount in the future, P is the equivalent payment or revenue amount in the present, i is a threshold annual interest rate, and n is the number of years in the future that F occurs. For a continuous revenue or payment stream, the previous equation can be summed over time to reach the following: P=A*[1−(1+i)⁻ⁿ]/i. Here, A is the “annuity” amount, or the yearly amount of payment or revenue. It is preferable to compare operating costs and revenues on a present value, or capital cost, basis because it provides a method of reducing long term cash streams to a single point in time, provides a technique to compare the tradeoffs between capital and operating costs, helps to evaluate the lifecycle economics of a project, and relates all costs to the financial status of the project at the present time. Any one or combination of the above-described cost measures may be used to determine the overall cost measure.

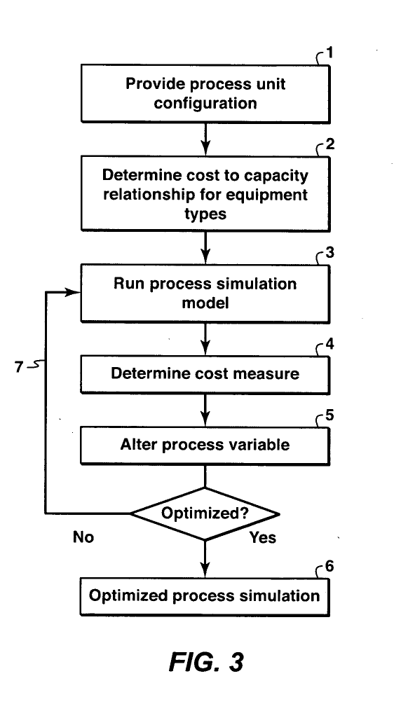

The method may be used to alter a process variable 5 in the process simulation model and re-determine the process simulation with the altered process variable. By altering one or more process variables 5 iteratively 7, re-running the process simulation model 3, and redetermining the cost measure 4, the method can be used to determine cost measure sensitivity to changes in selected process variables. The method may also be used to select a single process variable and iteratively alter the selected process variable to determine the lowest or optimized value for the cost measure for the selected process variable. FIG. 3 presents a block flow diagram of the steps included in an alternate embodiment of the invention used to determine the optimized 8 value for the cost measure for the selected process variable. The method may also be used to determine the lowest or optimized 8 value for the cost measure for a plurality of process variables. After determining the process variable value corresponding to the lowest or optimized 8 value for the cost measure for one or more process variables, such variables may be set to the determined low cost process variable value to obtain a cost optimized process simulation 9 The cost optimized process simulation 9 may be used to indicate the capacity of the equipment types that corresponds to the cost optimized process simulation 9.

One embodiment of the method includes determining the cost measure on the basis of an equipment cost measure for less than all of the equipment types included in a process unit or hydrocarbon fluid processing plant. In one embodiment the equipment cost measure includes a representation of the cost of higher cost equipment types. The higher cost equipment types are those equipment types that represent a disproportionate share of the total cost of constructing a hydrocarbon fluid processing plant. By selecting the higher cost equipment types for inclusion in the equipment cost measure and cost measure generally, the designer can simplify the designing method while still obtaining sufficient relative cost information to determine the optimal capacity of the higher cost equipment types and the other equipment types. In one embodiment, the higher cost equipment types are the equipment types that represent more than 10 percent of the cost of constructing a process unit that contains the higher cost equipment types. In alternate embodiments the higher cost equipment types may be the equipment types that represent more than 15, 20, 25 or 30 percent of the cost of constructing a process unit which contains the higher cost equipment types. In an LNG liquefaction plant the higher cost equipment types may be selected from any one or more of refrigerant compressors, cryogenic heat exchangers, motors, turbine drivers, steam boilers, and electrical generation and distribution equipment. Alternatively, the higher cost equipment types may be selected from any one or more of any subcombination of refrigerant compressors, cryogenic heat exchangers, motors, turbine drivers, steam boilers, and electrical generation and distribution equipment.

The methods described herein may be used to design one or more process units or a complete hydrocarbon fluid processing plant. The methods may also be used to expand the capacity of an existing process unit or hydrocarbon fluid processing plant. A unit or plant so designed may be constructed and operated more efficiently using the methods described herein. Such units and plants may be used to produce salable products which may be transported to market through pipelines and/or through the use of transportation vessels. Transportation vessels may include one or more of rail cars, tanker trucks, barges, ships or other means of traveling over land or seas.

The methods described herein may be encoded onto media that is suitable for being read and processed on a computer. For example, code to carry out the methods described herein may be encoded onto a magnetic or optical media which can be read by and copied to a personal or main frame computer. The methods may then be carried out by a design engineer using such a personal or main frame computer.

Certain features of the present invention are described in terms of a set of numerical upper limits and a set of numerical lower limits. It should be appreciated that ranges formed by any combination of these limits are within the scope of the invention unless otherwise indicated. Although some of the dependent claims have single dependencies in accordance with U.S. practice, each of the features in any of such dependent claims can be combined with each of the features of one or more of the other dependent claims dependent upon the same independent claim or claims.

The present invention has been described in connection with its preferred embodiments. However, to the extent that the foregoing description is specific to a particular embodiment or a particular use of the invention, this is intended to be illustrative only and is not to be construed as limiting the scope of the invention. On the contrary, it is intended to cover all alternatives, modifications, and equivalents that are included within the spirit and scope of the invention, as defined by the appended claims.

What is claimed is:

1. A method of designing a hydrocarbon fluid processing plant, comprising:
A) providing a process unit configuration for one or more processing units included in a hydrocarbon fluid processing plant;
B) determining a cost to capacity relationship for a plurality of equipment types included in said one or more processing units;
C) running a process simulation model to obtain a process simulation for said process unit configuration, said process simulation including the estimated capacity of said plurality of equipment types;
D) determining a cost measure for said process simulation, said cost measure including an equipment cost measure determined using said estimated capacity of said plurality of equipment types and said cost to capacity relationships;
E) altering a process variable in said process simulation model; and
F) repeating steps C through E a plurality of times.

2. A method according to claim 1, wherein said altering a process variable step E) includes altering multiple variables iteratively.

3. A method according to claim 2, wherein said altering a process variable step E) includes altering respective variables a plurality of times iteratively.

4. A method according to claim 3, wherein said hydrocarbon fluid processing plant is an LNG liquefaction plant.

5. A method according to claim 4, wherein said plurality of equipment types includes higher cost equipment types.

6. A method according to claim 5, wherein said higher cost equipment types is selected from refrigerant compressors, cryogenic heat exchangers, motors, turbine drivers, steam boilers, electrical generation and distribution equipment and combinations thereof.

7. A method according to claim 5, wherein said plurality of equipment types includes less than all the equipment types includes in said one or more processing units.

8. A method according to claim 5, wherein:
said running a process simulation model step C further includes said process simulation including a utility usage estimate; and
said determining a cost measure step D, further includes determining a utilities cost measure.

9. A method according to claim 8, wherein:
said running a process simulation model step C further includes said process simulation including a product quantity estimate; and
said determining a cost measure step D, further includes determining a product value cost measure.

10. A method according to claim 9, wherein said utilities cost measure, said product value cost measure and said equipment cost measure are all determined on a capital cost basis.

11. A method according to claim 10, wherein said cost measure is at least partially determined by summing said equipment cost measure, said utilities cost measure and said product value cost measure.

12. A method according to claim 11, further comprising:
G) determining for one or more of the process variables altered in step E, the value for said process variable that optimizes said cost measure.

13. A method according to claim 12, further comprising:
H) producing a process design for said one or more processing units based upon the value for said process variable that optimizes said cost measure.

14. A method according to claim 13, further comprising:
I) constructing a hydrocarbon fluid processing plant using said process design.

15. A method according to claim 14, further comprising:
J) producing a hydrocarbon fluid product from said hydrocarbon fluid processing plant.

16. A method according to claim 15, further comprising:
K) loading said hydrocarbon fluid product onto a transportation vessel.

17. A method of producing a hydrocarbon fluid product, said hydrocarbon fluid product produced from a hydrocarbon fluid processing plant, said hydrocarbon fluid processing plant designed at least partially using the following steps: a) providing a process unit configuration for one or more processing units included in said hydrocarbon fluid processing plant; b) determining a cost to capacity relationship for a plurality of equipment types included in said one or more processing units; c) running a process simulation model to obtain a process simulation for said process unit configuration, said process simulation including the estimated capacity of said plurality of equipment types; d) determining a cost measure for said process simulation, said cost measure including an equipment cost measure determined using said estimated capacity of said plurality of equipment types and said cost to capacity relationships; e) altering a process variable in said process simulation model; and f) repeating steps c through e a plurality of times, said method comprising producing said hydrocarbon fluid product from said hydrocarbon fluid processing plant.

18. A method according to claim 17, wherein said hydrocarbon fluid product is LNG.

19. A method according to claim 18, further comprising loading said LNG unto a transportation vessel.

20. A tangible media including a set of instructions readable by a computer, said set of instructions comprising:
A) a process configuration module suitable for inputting a process unit configuration for one or more processing units included in a hydrocarbon fluid processing plant;
B) a register module suitable for storing cost to capacity relationships for a plurality of equipment types included in said one or more processing units;
C) a process simulation model suitable for obtaining a process simulation for a process unit configuration, said process simulation suitable for estimating the capacity of said plurality of equipment types;
D) a cost calculation module suitable for determining a cost measure for said process simulation, said cost measure including an equipment cost measure determined using said estimated capacity of said plurality of equipment types and said cost to capacity relationships;
E) a process variable interfacing module suitable for allowing alteration of a process variable of said process simulation model;
F) a repetition module suitable for repeating modules C through E a plurality of times; and
G) an output module suitable for producing a data display.
